(19) United States
(12) Patent Application Publication
(10) Pub. No.: US 2009/0136231 A1
(43) Pub. Date: May 28, 2009

(54) Remote controlling system and gateway apparatus for controlling electronic appliances within space

(75) Inventor: Yen-Hung Lai, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/292,666

(22) Filed: Nov. 24, 2008

(30) Foreign Application Priority Data
Nov. 23, 2007 (TW) 096144391

(51) Int. Cl. H04B 10/00

(52) U.S. Cl. 398/112

(57) ABSTRACT

The present invention provides a remote controlling system for controlling a plurality of electronic appliances within a space, such as a home, an office, etc. Each of the electronic appliances includes a respective radiation-based signal receiver. By use of the remote controlling system, a user can conveniently control the electronic appliances in the situation through a user interface or an external communication network, such as an Internet.

### BACKGROUND OF THE INVENTION

1. Field of the Invention

The invention relates to a remote controlling system for controlling several electronic appliances within a space, e.g. a household, an office, a classroom, a factory, an exhibition field, etc. Each of the electronic appliances includes an individual radiation-based signal receiver. More particularly, it relates to a remote controlling system capable of controlling the electronic appliances with convenience, which the remote controlling system utilizes a radiation-based signal control (e.g. infrared remote control) and allows users to manipulate through a user interface or an external communication network.

2. Description of the Prior Art

Digital Home refers to a concept that a household network is disposed as a backbone to link personal computers, information appliances, digital video appliances and digital televisions, to form a Connected Home. Digital Home utilizes a Home Gateway combined with an external network system to complete an intelligent life with capabilities like household energy management, household security, household health care, remote household appliance repair, movie on demand, etc.

To eliminate various wirings packed in consumers' houses, the industry invests in research on wireless transmitting technology. There are some short-distance wireless techniques drawing public attention like Wi-Fi, ultra-wideband (UWB), Bluetooth and the wireless transmitting technique which follows the IEEE 802.15.4 standard. Between all of the techniques listed above, the structure under the IEEE 802.15.4 standard has been the focus, because it has features of power saving, low complexity and low cost.

However, in practical applications, every individual household appliance has its own remote controller, which is usually an infrared remote controller. It will not be easy for every family to entirely renew their household appliances.

Therefore, an embodiment of the invention is to provide a remote controlling system capable of controlling several electronic appliances within a space with convenience, which the remote controlling system utilizes a radiation-based signal control and allows users to manipulate through a user interface or an external communication network.

### SUMMARY OF THE INVENTION

A scope of the invention is to provide a remote controlling system for controlling N electronic appliances within a space. N is a natural number. Each of the N electronic appliances has an individual radiation-based signal receiver and functions according to an individual set of first instructions.

According to an embodiment of the invention, the remote controlling system includes M sensing devices, a controlling apparatus and a gateway device. Each of the M sensing devices includes an individual first receiving/transmitting module and an individual sensor. The sensor is electrically connected to the first receiving/transmitting module. The first receiving/transmitting module selectively receives a trigger signal based on a wireless local communication protocol. The sensor responds to the trigger signal and is used to generate a sensing signal around the sensor. The sensor broadcasts the sensing signal through the first receiving/transmitting module based on the wireless local communication protocol.

The controlling apparatus includes a radiation-based signal transmitter, a first storing device, a second receiving/transmitting module and a first processing module. The radiation-based signal transmitter covers the N radiation-based signal receiver in communicating. The first storing device stores a first look-up table. The first look-up table records K first commands and K sets of second instructions. Each set of the K sets of the second instructions corresponds to one of the K first commands. K is a natural number. The first processing module is used for fetching one of the K sets of the second instructions, and the first processing module controls the radiation-based signal transmitter to broadcast a set of radiation-based signals. The one set of the second instructions corresponds to the one of the first commands received by the second receiving/transmitting module. The set of the radiation-based signal represents the fetched set of the second instructions.

The gateway device includes a second storing device, a user interface, a third receiving/transmitting module, a network communication module and a second processing module. The second storing device stores a second look-up table. The second look-up table records K second commands and K activating rules. Each of the K activating rules corresponds to one of the K second commands and includes one of the first commands. The user interface is coupled to the storing device. The user interface enables a user to edit the second commands and the activating rules stored in the second storing device. The second processing module is used for receiving one of the second commands. The user links the gateway device to an external communication network through the network communication module. The one of the second commands of the user interface is one of the second commands inputted through the external communication network. The second processing module fetches the activating rule corresponding to the received second command. According to the fetched activating rule, the second processing module broadcasts the trigger signal to one or multiple sensing devices of the M sensing devices through the third receiving/transmitting module based on the wireless local communication protocol. The second processing module receives the sensing signals from the triggered sensing devices through the third receiving/transmitting module based on the wireless local communication protocol. The second processing module judges whether the received sensing signals reach a fetching standard. If the judging is positive, the second processing module broadcasts the first command of the fetching standard through the third receiving/transmitting module based on the wireless local communication protocol.

One of the N electronic appliances utilizes the own individual radiation-based signal receiver to receive the set of the broadcasted radiation-based signals. The one of the N electronic appliances converts the set of the received radiation-based signals into the one set of the second instructions. The one of the N electronic appliances judges whether one or multiple sets of the second instructions match each set of the first instructions. If the judging is positive, the one of the N electronic appliances functions according to the matched set of the first instructions.

Another scope of the invention is to provide a gateway device for controlling N electronic appliances within a space.

According to another embodiment of the invention, the N electronic appliances are wirelessly connected to a remote controller. The remote controller has a first storing device storing a first look-up table. The first look-up table records K first commands. Both M and N are natural numbers.

The gateway device includes a second storing device, a receiving/transmitting module and a processing module. The second storing device stores a second look-up table recording K second commands and K activating rules. Each of the K second commands corresponds to one of the K activating rules. Each of the K activating rules corresponds to one of the K first commands. K is a natural number.

The processing module is electrically connected to the second storing device and the receiving/transmitting module. The processing module receives a user command through an external communication network. The user command is one of the second commands. According to the one of the second commands, the processing module broadcasts a trigger signal to one of the M sensing devices through the receiving/transmitting module based on a wireless local communication protocol, for driving the one of the sensing devices to detect surroundings of the one of the sensing devices and to generate a sensing signal feeding back to the processing module. Afterward, the processing module judges whether the sensing signal reaches the activating rule. If the judging is positive, the processing module broadcasts the one of the first commands corresponding to the one of the activating rules to the N electronic appliances by a radiation-based signal transmitter through the receiving/transmitting module, for controlling the N electronic appliances.

The advantage and spirit of the invention may be understood by the following recitations together with the appended drawings.

### BRIEF DESCRIPTION OF THE APPENDED DRAWINGS

FIG. 1 is a schematic diagram illustrating a remote controlling system controlling a plurality of electronic appliances according to the invention.

FIG. 2 is a schematic diagram illustrating basic structure of a remote controlling system according to an embodiment of the invention.

FIG. 3A is a schematic diagram illustrating an example of the first look-up table storing in the first storing device.

FIG. 3B is a schematic diagram illustrating an example of the second look-up table storing in the second storing device.

FIG. 4 is a schematic diagram illustrating a gateway device 3 for controlling N electronic appliances within a space according to another embodiment of the invention.

### DETAILED DESCRIPTION OF THE INVENTION

The invention discloses a remote controlling system for controlling multiple electronic appliances within a space. More particularly, under the structure of the remote controlling system, users are allowed to control the electronic appliances through a user interface or an external communication network with convenience. The following descriptions are preferred embodiments of the invention illustrating the feature, idea, benefit and convenience of the invention.

The remote controlling system is used for controlling N electronic appliances within a space. N is a natural number. Each of the N electronic appliances has an individual radiation-based signal receiver and is able to function according to an individual set of first instructions.

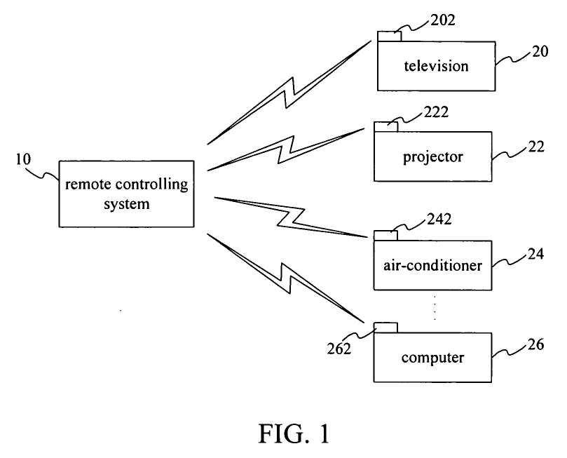

Please refer to FIG. 1. FIG. 1 is a schematic diagram illustrating a remote controlling system 10 controlling a plurality of electronic appliances according to the invention. As shown in FIG. 1, the plurality of the electronic appliances may include a television 20, a projector 22, an air-conditioner 24, a computer 26, etc. The plurality of the electronic appliances can receive a radiation-based signal broadcasted by the remote controlling system 10. The plurality of the electronic appliances may function according to the radiation-based signal.

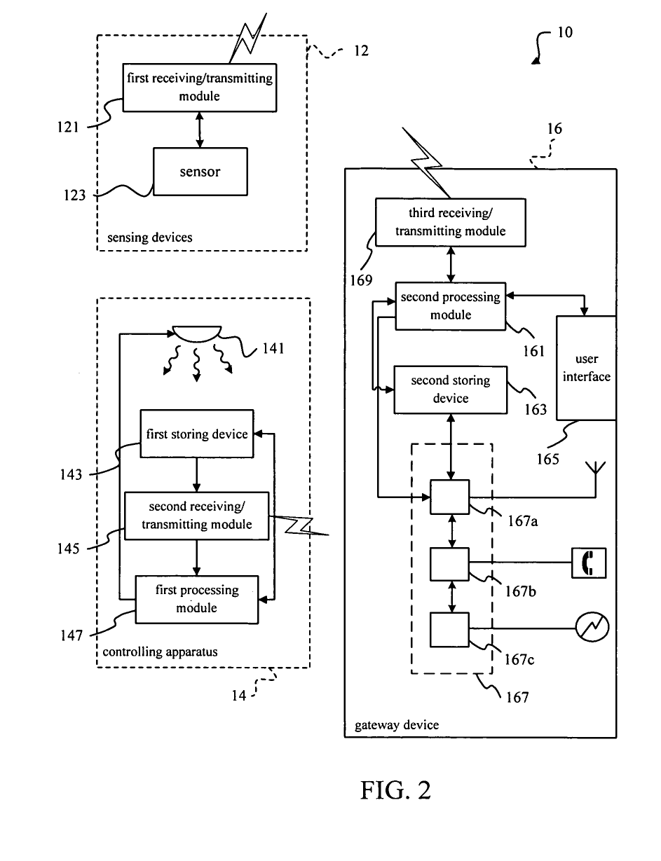

Please refer to FIG. 2. FIG. 2 is a schematic diagram illustrating the basic structure of a remote controlling system according to an embodiment of the invention.

As shown in FIG. 2, the remote controlling system 10 includes M sensing devices 12, a controlling apparatus 14 and a gateway device 16. M is a natural number.

Each of the M sensing devices 12 includes an individual first receiving/transmitting module 121 and an individual sensor 123. The controlling apparatus 14 includes a radiation-based signal transmitter 141, a first storing device 143, a second receiving/transmitting module 145 and a first processing module 147. The gateway device 16 includes a second processing module 161, a second storing device 163, a user interface 165, a network communication module 167 and a third receiving/transmitting module 169.

The first receiving/transmitting module 121 selectively receives a trigger signal based on a wireless local communication protocol. The sensor 123 is electrically connected to the first receiving/transmitting module 121. The sensor 123 responds to the trigger signal and is used to generate a sensing signal around the sensor 123. The sensor 123 broadcasts the sensing signal through the first receiving/transmitting module 121 based on the wireless local communication protocol.

In an embodiment, the wireless local communication protocol can be an IEEE 802.15.4 protocol, an IEEE 802.11 series protocol or a Bluetooth protocol.

The controlling apparatus 14 is disposed in the space, to allow the radiation-based signal transmitter to cover the N radiation-based signal receiver in communicating. The first storing device 143 stores a first look-up table. The first look-up table records K first commands and K sets of second instructions. Each set of the K sets of the second instructions corresponds to one of the K first commands. K is a natural number. The second receiving/transmitting module 145 selectively receiving one of the first commands based on the wireless local communication protocol. The first processing module 147 is electrically connected to the radiation-based signal transmitter 141, the first storing device 143 and the second receiving/transmitting module 145 respectively. The first processing module 147 is used for fetching one of the K sets of the second instructions, and the first processing module 147 controls the radiation-based signal transmitter 141 to broadcast a set of radiation-based signals. The one set of the second instructions corresponds to the one of the first commands received by the second receiving/transmitting module 145. The set of the radiation-based signal represents the fetched set of the second instructions.

In an embodiment, each of the broadcasted radiation-based signals is infrared. Each of the radiation-based signal receivers is an infrared receiver. The radiation-based signal transmitter is an infrared transmitter.

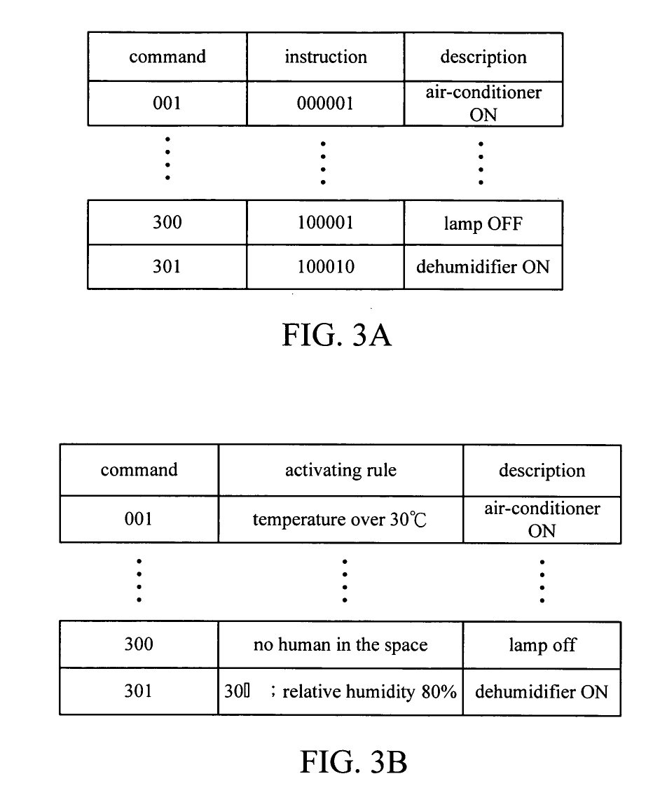

Please refer to FIG. 3A. FIG. 3A is a schematic diagram illustrating an example of the first look-up table storing in the first storing device 143. The first look-up table shown in FIG. 3A has command column, an instruction column, and also a description column for the convenience of user's editing.

The second storing device 163 stores a second look-up table recording K second commands and K activating rules. Each of the K activating rules corresponds to one of the K second commands and includes one of the first commands. The network communication module 167 can be linked to an external communication network. The second processing module 161 is electrically connected to the second storing device 163, the network communication module 167 and the third receiving/transmitting module 169 respectively. The second processing module 161 is used for receiving one of the second commands. The one of the second commands is one of the second commands inputted through the external communication network by a user. The second processing module 161 fetches the activating rule corresponding to the received second command. According to the fetched activating rule, the second processing module 161 broadcasts the trigger signal to one or multiple sensing devices 12 of the M sensing devices 12 through the third receiving/transmitting module 169 based on the wireless local communication protocol.

The second processing module 161 receives the sensing signals from the triggered sensing devices 12 through the third receiving/transmitting module 169 based on the wireless local communication protocol. The second processing module 161 judges whether the received sensing signals reach a fetching standard. For example, the fetching standard can be signal strength or signal format of the sensing signal.

If the judging is positive, the second processing module 161 broadcasts the first command of the fetching standard to the controlling apparatus 14 through the third receiving/transmitting module 169 based on the wireless local communication protocol. In practical application, the second processing module 161 can be operated in a remote controller, which further implants a set of key switches, to allow the user to manipulate the user interface 165 with convenience.

Please refer to FIG. 3B. FIG. 3B is a schematic diagram illustrating an example of the second look-up table storing in the second storing device 163. The second look-up table shown in FIG. 3B has an activating rule column, to allow the user to edit the controlling standards of each of the N electronic appliances. In an embodiment, the user interface 165 enables the user to edit the second commands and the activating rules stored in the second storing device 163. The user interface 165 is coupled to the storing device. In an embodiment, a house host can complete a setting, which is related to turning on an air-conditioner automatically when a sensor finds out that the indoor temperature is over 30° C., by editing a second command and an activating rule. According to the setting, when a pet stays in the house alone and the indoor temperature is over the activating rule, the air-conditioner can be turned on automatically to prevent the pet from getting ill. Besides the air-conditioner, the remote controlling system can be applied to a lamp, a dehumidifier, a television, or any electronic appliance with a radiation-based signal receiver.

One of the N electronic appliances, e.g. the television 20, the projector 22, the air-conditioner 24 or the computer 26, utilizes the own individual radiation-based signal receiver, e.g. the radiation-based signal receiver 202, 222, 242 or 262, to receive the set of the broadcasted radiation-based signals. The one of the N electronic appliances converts the set of the received radiation-based signals into the one set of the second instructions transmitted by the controlling apparatus 14. The one of the N electronic appliances judges whether one or multiple sets of the second instructions match each set of the first instructions. If the judging is positive, the one of the N electronic appliances functions according to the matched set of the first instructions.

In an embodiment, the space can be a household, an office, a classroom, a factory, an exhibition field, etc.

In an embodiment, the external communication network can be a local area network, an intranet, an internet, a radio telecommunication network or a public switched telephone network.

As shown in FIG. 2, in order to allow the user to remotely control aside from controlling through the user interface 165 within the space, the network communication module 167 is used to link an external communication network, e.g. radio telecommunication module 167a, a public switched telephone module 167b, a network connecting module 167c, etc. By means of said communication modules, the user may input a command remotely without manipulating the user interface 165 directly. The radio telecommunication module 167a can link to a radio telecommunication network. The public switched telephone module 167b can link to a public switched telephone network. The network connecting module 167c can link to a local area network, an intranet, an internet, etc.

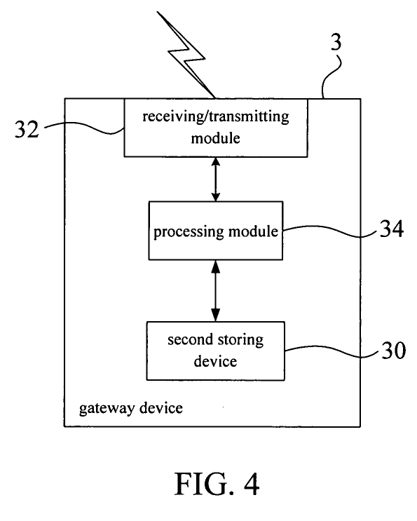

Please refer to FIG. 4. FIG. 4 is a schematic diagram illustrating a gateway device 3 for controlling N electronic appliances within a space according to another embodiment of the invention.

The N electronic appliances are wirelessly connected to a remote controller. The remote controller has a first storing device storing a first look-up table. The first look-up table records K first commands. Both M and N are natural numbers.

As shown in FIG. 4, the gateway device 3 includes a second storing device 30, a receiving/transmitting module 32 and a processing module 34. The second storing device 30 stores a second look-up table recording K second commands and K activating rules. Each of the K second commands corresponds to one of the K activating rules. Each of the K activating rules corresponds to one of the K first commands. K is a natural number.

The processing module 34 is electrically connected to the second storing device 30 and the receiving/transmitting module 32. The processing module 34 receives a user command through an external communication network. The user command is one of the second commands.

In an embodiment, the external communication network can be a local area network, an intranet, an internet, a radio telecommunication network or a public switched telephone network.

According to the one of the second commands, the processing module 34 broadcasts a trigger signal to one of the M sensing devices through the receiving/transmitting module based on a wireless local communication protocol, for driving the one of the sensing devices to detect surroundings of the one of the sensing devices and to generate a sensing signal feeding back to the processing module 34. Afterward, the processing module 34 judges whether the sensing signal reaches the activating rule. If the judging is positive, the processing module 34 broadcasts the one of the first commands corresponding to the one of the activating rules to the N electronic appliances by a radiation-based signal transmitter through the receiving/transmitting module 32, for controlling the N electronic appliances. The radiation-based signal transmitter can be, but not limited to, an infrared transmitter.

In an embodiment, the wireless local communication protocol can be an IEEE 802.15.4 protocol, an IEEE 802.11 series protocol or a Bluetooth protocol.

The N electronic appliances are able to function according to an individually set of the first instructions. The first look-up table further records K sets of the second instructions. Each set of the K sets of second instructions corresponding to one of the K first commands.

If the processing module 34 judges that the sensing signal reaches the activating rule, the processing module 34 broadcasts the one of the first commands corresponding to the activating rule and the one set of the second instructions corresponding to the one of the first commands to the N electronic appliances through the receiving/transmitting module 32. Each of the N electronic appliances receives the one of the first commands and the one set of the second instructions broadcasted by the receiving/transmitting module 32 and judges whether the one or multiple sets of the second instructions match the individual set of the first instructions, and if the judging is positive, the one of the N electronic appliances functions according to the matched set of the first instructions.

In summary, the radiation-based signal control (e.g. infrared remote control) applied in the invention is a common technique in daily life. For a company, the present industrial electronic equipment, which cooperates with the remote controlling system of the invention, does not need to be updated to match said wireless transmitting standard. The customer does not need to upgrade currently owned electronic appliances to new ones matched with the wireless transmitting standard. Therefore, compared to the IEEE 802.15.4 standard, the radiation-based signal controlling technique applied in the invention has better industrial application. In other words, a connected home structure utilizing an infrared transmitting technique can be widespread in every family, and even in any space which needs to eliminate real wiring of electronic appliances, e.g. a household, an office, a classroom, a factory, an exhibition field, etc.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A remote controlling system for controlling N electronic appliances within a space, N being a natural number, each of the N electronic appliances having an individual radiation-based signal receiver and functioning according to an individual set of first instructions, the remote controlling system comprising:
M sensing devices, M being a natural number, each of the M sensing apparatuses comprising:
an individual first receiving/transmitting module, the first receiving/transmitting module selectively receiving a trigger signal based on a wireless local communication protocol; and
an individual sensor electrically connected to the first receiving/transmitting module, the sensor responding to the trigger signal to generate a sensing signal around the sensor and broadcasting the sensing signal through the first receiving/transmitting module based on the wireless local communication protocol;
a controlling apparatus, comprising:
a radiation-based signal transmitter, the radiation-based signal transmitter covering the N radiation-based signal receiver in communicating;
a first storing device storing a first look-up table, the first look-up table recording K first commands and K sets of second instructions, each set of the K sets of the second instructions corresponding to one of the K first commands, K being a natural number;
a second receiving/transmitting module, the second receiving/transmitting module selectively receiving one of the first commands based on the wireless local communication protocol; and
a first processing module electrically connected to the radiation-based signal transmitter, the first storing device and the second receiving/transmitting module respectively, the first processing module being used for fetching one of the K sets of the second instructions, the one set of the second instructions corresponding to the one of the first commands received by the second receiving/transmitting module, the first processing module controlling the radiation-based signal transmitter to broadcast a set of radiation-based signals, the set of the radiation-based signal representing the fetched set of the second instructions; and
a gateway device, comprising:
a second storing device storing a second look-up table, the second look-up table recording K second commands and K activating rules, each of the K activating rules corresponding to one of the K second commands and comprising one of the first commands;
a third receiving/transmitting module;
a network communication module, the network communication module being linked to an external communication network; and
a second processing module electrically connected to the second storing device, the third receiving/transmitting module and the network communication module respectively, the second processing module being used for receiving one of the second commands, the one of the second commands being inputted through the external communication network by a user, the second processing module fetching the activating rule corresponding to the received second command, according to the fetched activating rule, the second processing module broadcasting the trigger signal to one or multiple sensing devices of the M sensing devices through the third receiving/transmitting module based on the wireless local communication protocol, the second processing module receiving the sensing signals from the triggered sensing devices through the third receiving/transmitting module based on the wireless local communication protocol, the second processing module judging whether the received sensing signals reach a fetching standard, if the judging is positive, the second processing module broadcasting the first command of the fetching standard through the third receiving/transmitting module based on the wireless local communication protocol;
wherein one of the N electronic appliances utilizes the own individual radiation-based signal receiver to receive the set of the broadcasted radiation-based signals, converts the set of the received radiation-based signals into the one set of the second instructions, judges whether one or multiple sets of the second instructions match each set of the first instructions, and if the judging is positive, functions according to the matched set of the first instructions.

2. The remote controlling system of claim 1, wherein the external communication network is one selected from the group consisting of a local area network, an intranet, an internet, a radio telecommunication network and a public switched telephone network.

3. The remote controlling system of claim 1, wherein each of the broadcasted radiation-based signals is infrared, and -each of the radiation-based signal receivers is an infrared receiver, and the radiation-based signal transmitter is an infrared transmitter.

4. The remote controlling system of claim 1, wherein the gateway device further comprises a user interface coupled to the storing device, and the user interface enables the user to edit the second commands and the activating rules stored in the second storing device.

5. The remote controlling system of claim 1, wherein the wireless local communication protocol is one selected from the group consisting of an IEEE 802.15.4 protocol, an IEEE 802.11 series protocol and a Bluetooth protocol.

6. A gateway device for controlling N electronic appliances within a space, M sensing devices being disposed within the space, the N electronic appliances being wirelessly connected to a remote controller, the remote controller having a first storing device storing a first look-up table, the first look-up table recording K first commands, both M and N being natural numbers, the gateway device comprising:
a second storing device storing a second look-up table, the second look-up table recording K second commands and K activating rules, each of the K second commands corresponding to one of the K activating rules, each of the K activating rules corresponding to one of the K first commands, K being a natural number;
a receiving/transmitting module; and
a processing module electrically connected to the second storing device and the receiving/transmitting module, the processing module receiving a user command through an external communication network, the user command being one of the second commands, according to the one of the second commands, the processing module broadcasting a trigger signal to one of the M sensing devices through the receiving/transmitting module based on a wireless local communication protocol, for driving the one of the sensing devices to detect surroundings of the one of the sensing devices, the one of the sensing devices generating a sensing signal feeding back to the processing module, the processing module judging whether the sensing signal reaches the activating rule, if the judging is positive, the processing module broadcasting the one of the first commands corresponding to the one of the activating rules to the N electronic appliances by a radiation-based signal transmitter through the receiving/transmitting module, for controlling the N electronic appliances.

7. The gateway device of claim 6, wherein one of the N electronic appliances are able to function according to an individually set of the first instructions, and the first look-up table further records K sets of the second instructions, each set of the K sets of second instructions corresponding to one of the K first commands, and if the processing module judges that the sensing signal reaches the activating rule, the processing module broadcasts the one of the first commands corresponding to the activating rule and the one set of the second instructions corresponding to the one of the first commands to the N electronic appliances through the receiving/transmitting module, and each of the N electronic appliances receives the one of the first commands and the one set of the second instructions broadcasted by the receiving/transmitting module and judges whether the one or multiple sets of the second instructions match the individual set of the first instructions, and if the judging is positive, the one of the N electronic appliances functions according to the matched set of the first instructions.

8. The gateway device of claim 6, wherein the external communication network is one selected from the group consisting of a local area network, an intranet, an internet, a radio telecommunication network and a public switched telephone network.

9. The gateway device of claim 6, wherein the wireless local communication protocol is one selected from the group consisting of an IEEE 802.15.4 protocol, an IEEE 802.11 series protocol and a Bluetooth protocol.

10. The gateway device of claim 6, wherein the radiation-based signal transmitter is an infrared transmitter.
